(19) United States
(12) Patent Application Publication
(10) Pub. No.: US 2026/0234758 A1
(43) Pub. Date: Aug. 13, 2026

(54) HIGH RECYCLE CONTENT ALUMINUM ALLOYS, ALUMINUM ALLOY PRODUCTS, AND METHODS OF PRODUCING A BRAZED PRODUCT

(71) Applicant: Novelis Koblenz GmbH, Koblenz (DE)

(72) Inventors: Fabian Ritz, Ötzingen (DE); Axel Alexander Maria Smeyers, Heist op den Berg (BE); Steven Kirkham, Ransbach-Baumbach (DE); Bernd Jacoby, Limburg (DE)

(73) Assignee: Novelis Koblenz GmbH, Koblenz (DE)

(21) Appl. No.: 19/149,685

(22) PCT Filed: Jan. 18, 2024
(86) PCT No.: PCT/IB2024/050495

§ 371 Date: Jul. 21, 2025

Related U.S. Application Data
(60) Provisional application No. 63/481,252, filed on Jan. 24, 2023.

(51) Int. Cl. C22C 21/00; B23K 1/00; B23K 35/00; B23K 35/28; F28F 21/08

(52) U.S. Cl. CPC C22C 21/00; B23K 1/0012; B23K 35/002; B23K 35/288; F28F 21/084

(57) ABSTRACT

Disclosed herein are aluminum alloys which may be used for a core alloy. The aluminum alloy may be produced from 50% or greater of recycled aluminum alloy material and exhibit good strength and corrosion resistance for use in heat exchangers. The aluminum alloy tolerates higher amounts of recycled aluminum alloy material while maintaining corrosion resistance and suitability for controlled atmosphere brazing processes. The present disclosure also provides unclad aluminum alloy products and clad aluminum alloy products including the aluminum alloy as a core layer and/or one or more cladding layers.

### CROSS-REFERENCE TO RELATED APPLICATION

This application claims the benefit of and priority to U.S. Provisional Application No. 63/481,252, filed Jan. 24, 2023, which is incorporated herein by reference in its entirety for all intents and purposes.

### FIELD

This disclosure relates to the fields of material science, material chemistry, metallurgy, aluminum alloys, aluminum alloy products, aluminum fabrication, and related fields. More specifically, the disclosure provides a novel aluminum alloy that can be used in a variety of applications, including, for example, as a core alloy for a clad aluminum alloy product, that can be produced from recycled aluminum alloy materials.

### BACKGROUND

There has long been an interest in using recycled aluminum alloy materials for producing aluminum alloys. Incorporating recycled aluminum alloy materials leads to decreased cost and time associated with producing primary aluminum as well as decreased carbon emissions (e.g., decreased global impact and specific carbon footprints). Recycled aluminum alloy materials, however, may be unsuitable for use in preparing high performance aluminum alloys as the recycled aluminum alloy materials may contain higher levels of certain undesirable elements. For example, aluminum alloy parts used in a heat exchanger require high corrosion resistance among other properties. Therefore, aluminum alloy parts used in a heat exchanger have strict compositional limits. The strict bounds on composition and processing for many high performance aluminum alloy products severely limit the amounts and types of recycled aluminum alloy materials and process-related scraps that can be used. For example, recycled scrap may include certain elements in amounts that adversely affect the mechanical properties of an aluminum alloy and its corrosion resistance. For these reasons, it is impractical to use high amounts of recycled scrap in producing certain aluminum alloys, especially for heat exchangers that require strictly controlled aluminum alloy compositions and material properties.

### SUMMARY

Covered embodiments of the invention are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

Provided herein are recycling-friendly aluminum alloys for numerous applications. The aluminum alloys described herein comprise 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al. In some embodiments, the aluminum alloy comprises 0.7-1.3 wt. % Si, up to 0.6 wt. % Fe, 0.1-0.6 wt. % Cu, 0.9-2 wt. % Mn, up to 0.2 wt. % Mg, up to 0.25 wt. % Cr, up to 0.4 wt. % Zn, up to 0.2 wt. % Ti, up to 0.25 wt. % Zr, up to 0.15 wt. % of impurities, and remainder Al. In some embodiments, the aluminum alloy comprises 0.8-1.3 wt. % Si, up to 0.4 wt. % Fe, 0.1-0.5 wt. % Cu, 0.9-2 wt. % Mn, up to 0.1 wt. % Mg, up to 0.2 wt. % Cr, up to 0.3 wt. % Zn, up to 0.2 wt. % Ti, up to 0.2 wt. % Zr, up to 0.15 wt. % of impurities, and remainder Al. In some embodiments, the aluminum alloy comprises 0.85-1.3 wt. % Si, up to 0.55 wt. % Fe, 0.1-0.55 wt. % Cu, 1-2 wt. % Mn, up to 0.2 wt. % Mg, up to 0.15 wt. % Cr, up to 0.2 wt. % Zn, up to 0.15 wt. % Ti, up to 0.15 wt. % Zr, up to 0.15 wt. % of impurities, and remainder Al. In some embodiments, the aluminum alloy comprises 0.85-1.25 wt. % Si, up to 0.5 wt. % Fe, 0.2-0.5 wt. % Cu, 1.2-1.8 wt. % Mn, up to 0.15 wt. % Mg, up to 0.10 wt. % Cr, up to 0.10 wt. % Zn, up to 0.1 wt. % Ti, up to 0.1 wt. % Zr, up to 0.15 wt. % of impurities, and remainder Al. In some embodiments, the aluminum alloy comprises 0.85-1.15 wt. % Si, up to 0.38 wt. % Fe, 0.23-0.43 wt. % Cu, 1.4-1.6 wt. % Mn, up to 0.1 wt. % Mg, up to 0.05 wt. % Cr, up to 0.05 wt. % Zn, up to 0.1 wt. % Ti, up to 0.05 wt. % Zr, up to 0.15 wt. % of impurities, and remainder Al.

In some embodiments, the aluminum alloy comprises 0.9-1.1 wt. % Si, up to 0.35 wt. % Fe, 0.23-0.43 wt. % Cu, 1.4-1.6 wt. % Mn, up to 0.05 wt. % Mg, up to 0.03 wt. % Cr, up to 0.04 wt. % Zn, up to 0.1 wt. % Ti, up to 0.01 wt. % Zr, up to 0.15 wt. % of impurities, and remainder Al. In some embodiments, the aluminum alloy comprises greater than 50% of recycled aluminum alloy materials. In some embodiments, the recycled aluminum alloy materials comprise used clad aluminum alloy products comprising a mixture of 3xxx series aluminum alloys and 4xxx series aluminum alloys. In some embodiments, the aluminum alloy has a solidus temperature of 600° C. or greater. In some embodiments, an ultimate tensile strength of the aluminum alloy is from 125 MPa to 200 MPa. In some embodiments, a yield strength of the aluminum alloy is from 35 MPa to 80 MPa. In some embodiments, the aluminum alloy comprises 0.85-1.25 wt. % Si, up to 0.50 wt. % Fe, 0.2-0.55 wt. % Cu, 1.2-1.8 wt. % Mn, up to 0.15 wt. % Mg, up to 0.1 wt. % Cr, up to 0.1 wt. % Zn, up to 0.1 wt. % Ti, up to 0.05 wt. % Zr, up to 0.15 wt. % of impurities, and remainder Al, wherein the aluminum alloy comprises greater than 50% of recycled aluminum alloy materials comprising used clad aluminum alloy products comprising a mixture of 3xxx series aluminum alloys and 4xxx series aluminum alloys; and wherein the aluminum alloy has a solidus temperature of 600° C. or greater. Provided herein are unclad aluminum alloy products comprising the aluminum alloy described herein. Provided herein are clad aluminum alloy products comprising a core layer comprising the aluminum alloy described herein.

Provided herein is a clad aluminum alloy product, comprising: a core layer, wherein the core layer has a first side and a second side; at least one cladding layer on the first side or the second side; wherein core layer and/or the cladding layer comprises 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al. In some embodiments, the at least one cladding layer comprises a 1xxx, 3xxx, 4xxx or 7xxx series aluminum alloy. In some embodiments, a heat exchanger comprises the clad aluminum alloy product described herein.

Provided herein is a method of forming a brazing product, the method comprising the steps of: providing one or more metal parts; providing a clad aluminum alloy product on or between the one or more metal parts to form an assembly, wherein the clad aluminum alloy product comprises a core layer; brazing the assembly to join the clad aluminum alloy product and the one or more metal parts to produce a brazed assembly; optionally applying a flux load before brazing; and cooling the brazed assembly, wherein the core layer comprises 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al. In some embodiments, the brazing comprises controlled atmosphere brazing. In some embodiments, the assembly is brazed at a brazing temperature from 560° C. to 620° C.

Further aspects, objects, and advantages will become apparent upon consideration of the detailed description of non-limiting examples that follow.

### BRIEF DESCRIPTION OF THE FIGURES

FIG. 1 provides a graph showing the effect of alloying elements on the solidus temperature of an aluminum alloy as a function of the silicon concentration in the aluminum alloy. A typical CAB-brazing temperature is also shown.

FIG. 2 provides a graph showing the impact of the amount of primary aluminum on the carbon footprint of aluminum alloy products.

### DETAILED DESCRIPTION

Described herein are novel aluminum alloys that can used, for example, as core aluminum alloys, clad aluminum alloy products, unclad aluminum alloy products (finstock, brackets, etc.), and related methods of producing a brazeable product using the novel aluminum alloys. The aluminum alloys described herein are “recycle-friendly” aluminum alloys that can be used in a variety of applications, including, for example, as a core alloy in a clad aluminum product (e.g., a brazing sheet), that can replace core aluminum alloys produced from a high content of primary aluminum. The aluminum alloys described herein can tolerate higher amounts of silicon (Si) and copper (Cu) than conventional 3xxx series aluminum alloys (e.g., used for brazing sheets) allowing the use of recycled aluminum alloy materials. Specifically, high-Si containing aluminum alloy scrap can be used to produce the aluminum alloys described herein. For example, clad aluminum alloy products may be produced from a mixture of 3xxx series aluminum alloys and 4xxx series aluminum alloys. 4xxx series aluminum alloys include Si as the predominant alloying element. The aluminum alloys described herein can be produced from high-Si containing aluminum alloy scrap, such as clad aluminum alloy products, and still maintain desirable properties. Despite having a higher content of Si and Cu, the aluminum alloys described herein maintain a solidus temperature at or above 600° C. for use as a core alloy or an unclad alloy. The aluminum alloys described herein include a careful balance of alloying elements that provide an aluminum alloy product having an adequate solidus temperature for standard Controlled Atmosphere Brazing (CAB) with relatively low flux loads, while having good corrosion resistance properties and providing increased strength compared to AA3003 aluminum alloy.

Conventional aluminum alloys for use as core alloys (e.g., 3xxx series aluminum alloys) used in heat exchanger products cannot be produced with a high content of recycled aluminum alloy materials, having higher amounts of Si, without sacrificing the aluminum alloy's properties. However, there is a significant market need for aluminum alloys produced from recycled aluminum alloy materials to reduce carbon footprint. Besides factors like price and material properties, the recycled content of specific aluminum alloys is increasingly important for the automotive and non-automotive industries. Although there are aluminum alloys available on the market that can incorporate high amounts of recycled aluminum alloy materials that have wide chemistry windows for alloying elements (e.g., Mg, Si, Cu, and Mn), these aluminum alloys cannot be considered for critical components (e.g., corrosion critical parts in heat exchangers). For these critical components, aluminum alloy compositions may have stricter compositional limits to achieve desired properties. As one example, aluminum alloys used in heat exchangers require a balance of alloying elements for good brazing properties and corrosion resistance. For example, Si and Cu can lower the solidus temperature of the aluminum alloy which is critical for brazing at about 600° C. An aluminum alloy having a solidus temperature less than 600° C. may be susceptible to local melting during brazing, thereby limiting the use of recycled aluminum alloy materials containing higher amounts of Si and Cu. Additionally, the Mg content in aluminum alloys for use as core alloys can affect the amount of flux needed for the CAB process. Aluminum alloys that include high amounts of Mg (e.g., greater than 0.2 wt. %) require higher flux loads. However, higher flux loads may result in higher amounts of flux residue on the material surface after brazing. This may have functional implications, for example, flux residues can cause uneven painting and/or poor adherence during lacquering, if necessary.

The aluminum alloys described herein incorporate higher amounts of recycled aluminum alloy materials (e.g., high-Si containing aluminum alloy scrap), as compared to conventional core aluminum alloys, and still maintain good mechanical properties, for example, for brazing applications. Specifically, the aluminum alloys described herein include a careful balance of alloying elements that surprisingly provide an aluminum alloy product having an adequate temperature for brazing with relatively low flux loads (e.g., less than 5 g/m²), while having good corrosion resistance properties despite being produced from high amounts of recycled aluminum alloy materials. In some embodiments, the aluminum alloy described herein is a modified 3xxx series aluminum alloy that includes a balance of silicon (Si), copper (Cu), magnesium (Mg), and manganese (Mn) that can be used in brazing applications with relatively low flux loads. Without being bound by theory, adding Mn (e.g., from 0.9 wt. % to 2 wt. %) increases the solidus temperature of the aluminum alloy, thereby allowing higher amounts of Si and Cu, for example, from recycled aluminum alloy materials. Additionally, the aluminum alloy may include 0.2 wt. % or less of Mg for brazing with lower flux loads to minimize or reduce the amount of the flux residue and thereby avoid or at least minimize flushing and cleaning operations after CAB. The combination of properties provides an aluminum alloy that can be used as a core alloy for a clad aluminum alloy product. The aluminum alloy composition described herein provides an environmentally friendlier alternative to the use of existing 3xxx series aluminum alloys for clad aluminum products.

The aluminum alloys described herein possess a combination of properties that are suitable for the heat exchanger market (e.g., including the electrification of vehicles). In summary, the aluminum alloys described herein possess a combination of higher relative recycled contents (e.g., 50 wt. % to 70 wt. %) that can be sourced from high-Si containing materials to lower the carbon footprint of the aluminum alloy, having a higher Mn content (e.g., from 0.9 wt. % to 2 wt. %) to compensate for the Si and Cu that lower the solidus temperature of the aluminum alloy, and has a Mg content (e.g., 0.2 wt. % or less) that allows for relatively low flux loads, e.g., that support lower conductivity of standard coolants with little or no need for post-braze cleaning and/or flushing operations. The newly developed aluminum alloy can be produced with high recycle rates and can be brazed with lower amounts of flux ensuring a uniform painting without the need for cleaning of brazed parts.

### Definitions and Descriptions

The terms “invention,” “the invention,” “this invention,” and “the present invention” used herein are intended to refer broadly to all of the subject matter of this patent application and the claims below. Statements containing these terms should be understood not to limit the subject matter described herein or to limit the meaning or scope of the patent claims below.

In this description, reference is made to alloys identified by aluminum industry designations, such as “series” or “3xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, the meaning of “a,” “an,” or “the” includes singular and plural references unless the context clearly dictates otherwise.

As used herein, a plate generally has a thickness of greater than about 15 mm. For example, a plate may refer to an aluminum product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum product having a thickness of less than about 4 mm. For example, a sheet may have a thickness of less than about 4 mm, less than about 3 mm, less than about 2 mm, less than about 1 mm, less than about 0.5 mm, less than about 0.3 mm, or less than about 0.1 mm.

As used herein, the “solidus temperature” of an aluminum alloy refers to the highest temperature at which an aluminum alloy is completely in solid state before partial melting begins.

Reference is made in this application to alloy temper or condition. For an understanding of the alloy temper descriptions most commonly used, see “American National Standards (ANSI) H35 on Alloy and Temper Designation Systems.” An F condition or temper refers to an aluminum alloy as fabricated. An O condition or temper refers to an aluminum alloy after annealing. An Hxx condition or temper, also referred to herein as an H temper, refers to an aluminum alloy after cold rolling with or without thermal treatment (e.g., annealing). Suitable H tempers include HX1, HX2, HX3 HX4, HX5, HX6, HX7, HX8, or HX9 tempers. For example, the aluminum alloy can be strain hardened to various tempers, for example, H16, H18, or other H1X tempers.

Reference is made in this application to recycled content. The term “recycled content” incorporates, but is not limited to, what is typically called internal process waste or scrap but also different types of external scrap, for instance, post-consumer scrap, remelt scrap ingot (RSI), among others. Since primary aluminum (aside from the alloying elements and hardeners) is responsible for the majority of the Scope 3 emissions (described below), all types of recycled content inputs (whether they are internal or external scrap) contribute to more sustainable aluminum alloy products and support possible closed-loop material circularity (production) processes.

The following aluminum alloys are described in terms of their elemental composition in weight percentage (wt. %) based on the total weight of the alloy. In certain examples of each alloy, the remainder is aluminum, with a maximum wt. % of 0.15% for the sum of the impurities.

As used herein, “controlled atmosphere brazing” or “CAB” refers to a brazing process which utilizes an inert gas atmosphere, for example, nitrogen or argon, in the brazing of the various alloy articles.

As used herein, “electrochemical potential” refers to a material's amenability to a redox reaction. Electrochemical potential can be employed to evaluate resistance to corrosion of aluminum alloys described herein. A negative value can describe a material that is easier to oxidize (e.g., lose electrons or increase in oxidation state) when compared to a material with a positive or less negative electrochemical potential. A more positive value can describe a material that is easier to reduce (e.g., gain electrons or decrease in oxidation state) when compared to a material with a negative or less positive electrochemical potential. Electrochemical potential, as used herein, is a vector quantity expressing magnitude and direction.

As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

### Clad Aluminum Alloy Products

The terms “cladding,” “clad,” “cladding layer,” “clad layer,” and the related terms are used generally to refer to a relatively thin surface layer of clad aluminum alloy products. The terms “core,” “core layer,” and the related terms are used to refer to a relatively thicker layer of clad aluminum alloy products. In some examples, a clad aluminum alloy product (e.g., a clad sheet aluminum alloy) can have cladding layers on both sides of the core layer, in which case a core layer is an internal layer of the aluminum material. However, a clad aluminum alloy product (e.g., a clad sheet aluminum alloy) can alternatively have a cladding layer on only one side of the core layer, in which case the core layer can also be a surface. The core layer and cladding layer(s) typically have different chemical compositions. In some cases, a clad aluminum alloy product can have two different cladding layers with different compositions and properties.

It is to be understood that clad aluminum alloy products suitable for brazing applications do not necessarily contain only a core layer and one or two cladding layers. Clad aluminum alloy products can contain other layers (e.g., to form multilayer aluminum materials), some of which may be referred to as “interlayers,” “outer layers,” “liners,” and by other related terms. For example, clad aluminum alloy products can have 2, 3, 4, 5, 6 or more distinct layers, each having a certain function. More generally, clad aluminum alloy products can have as many layers as can be stacked and bonded together in one or more operations. In the commercial context, one possible limiting factor is the cost of production and/or scrap generated during production of clad aluminum alloy products, which can become too high with the increased number of layers for the clad aluminum alloy products to be commercially viable. In the context of clad aluminum alloy products suitable for brazing applications, one or more of the cladding layers can be the portion of the product that melts during a braze cycle. A liner can be a layer that is not expected to melt during a braze cycle and may confer some other benefits, such as corrosion resistance or increased strength, to the clad aluminum alloy products. A core can also include multiple layers, such as one or more interlayers on one or both sides of the main core layer.

In some embodiments, the clad aluminum alloy products include a core layer and at least one cladding layer. In some cases, the clad aluminum alloy products include a core layer, a first cladding layer, and a second cladding layer. In these cases, the first cladding layer can be adjacent to and contact the first side of the core layer to form a first interface (i.e., no layers intervene between the first cladding layer and the first side of the core layer). The second cladding layer can be adjacent to and contact the second side of the core layer to form a second interface (i.e., no layers intervene between the second cladding layer and the second side of the core layer). The first cladding layer and the second cladding layer may each comprise the alloy compositions described herein. In some embodiments, the core layer is clad on only one side. In other embodiments, the core layer is clad on both sides. In other embodiments, the core layer is clad on one side of the core layer and a water sideliner or other layer is placed on the other side of the core layer. In other embodiments, the core layer is unclad and is intended for use with other clad aluminum alloy products.

The aluminum alloy composition described herein can be used as a core layer of a clad aluminum alloy product. The aluminum alloy can tolerate higher amounts of Si than some of the standard 3xxx series aluminum alloys (e.g., AA3003 aluminum alloy). As such, the aluminum alloy for the core layer can be produced from higher amounts of relatively high Si containing recycled aluminum alloys. For example, clad aluminum alloy products may include a core layer comprising a 3xxx series aluminum alloy and one or more cladding layers comprising a 4xxx series aluminum alloy. The 4xxx series aluminum alloy includes Si as the predominant alloying element. The higher concentration of Si in the clad aluminum alloy product limits its use as recycled aluminum for producing core alloys for brazing sheets. The aluminum alloys described herein can tolerate higher amounts of Si and therefore can utilize clad aluminum alloy products as recycle material. In particular, the aluminum alloys described herein can be produced from more than 50% of recycled aluminum alloy materials (e.g., mixed 3xxx/4xxx series aluminum alloy process scrap).

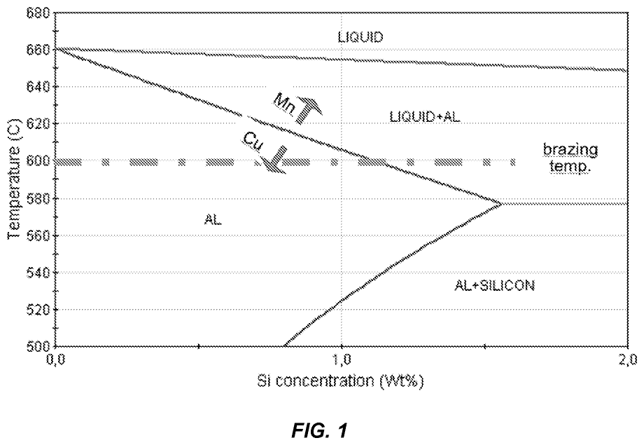

FIG. 1 provides a graph showing the effect of alloying elements on the solidus temperature of an aluminum alloy. The Si and Cu concentrations both decrease the solidus temperature of the aluminum alloy, while Mn increases the solidus temperature of the aluminum alloy. Recycled aluminum alloy materials that include higher amounts of Si (e.g., clad aluminum alloy products) can lower the solidus temperature of the aluminum alloy. Specifically, a core alloy having a solidus temperature less than 600° C. may be susceptible to local melting during brazing. The aluminum alloy composition for the core alloy described herein includes a balance of Si, Cu, and Mn that provides a solidus temperature at or greater than 600° C. The Mn in the aluminum alloy composition compensates the Si and Cu to produce an aluminum alloy having a desirable solidus temperature for brazing application.

Additionally, the aluminum alloy described herein includes up to 0.2 wt. % Mg. The amount of Mg in the aluminum alloy for a core layer is carefully balanced to provide good properties for brazing (e.g., by the CAB process). Aluminum alloys that include greater than 0.2 wt. % Mg may require higher flux loads during the CAB process. However, using higher flux loads can cause increased flux residues after brazing. During the operation of a heat exchanger, the flux residues may cause gel-formations of certain coolants which could lower the efficiency of a heat exchanger. Therefore, intensive flushing and cleaning may be required, in case of the CAB process, to remove excessive flux residues. Vacuum brazing is also an alternative processing option for this reason. The aluminum alloy described herein includes up to 0.2 wt. % Mg, which enables the use of lower flux loads during brazing. The lower flux load can limit the amount of flux residue to avoid the need for flushing and cleaning of the brazed heat exchangers.

The clad aluminum alloy products and methods described herein can be used in industrial applications including sacrificial parts, filler parts, heat dissipation, packaging, and building materials. In some embodiments, the clad aluminum alloy products described herein can be employed in aluminum alloy parts for heat exchangers, including use with dissimilar metals and as/or with extruded components. Specifically, the clad aluminum alloy products described herein can form brazed products. Suitable cladding layers and core layers for use in such clad aluminum alloy products are described below.

### Core Layer

Described below are novel aluminum alloy compositions that can be produced with a relatively high content of recycled aluminum alloy materials. In some embodiments, the aluminum alloy described herein can be used as a core layer, in combination with a cladding layer, to produce a clad aluminum alloy product described herein, or without a clad layer to produce a bare unclad core alloy. The resulting clad aluminum alloy products are suitable for use in a variety of applications, including for instance, as use as a corrosion resistant brazing sheet package in manufacturing cold plates (e.g., cooling plates or battery cooling plates) for electric vehicle batteries.

In some embodiments, the aluminum alloy is a modified 3xxx series aluminum alloy. For example, the aluminum alloy can be a modified AA3003 aluminum alloy. The aluminum alloys described herein exhibit good brazing performance and corrosion resistance despite being produced of relatively high amounts of recycled aluminum alloys (e.g., Si containing aluminum materials) in comparison to unmodified 3xxx series aluminum alloys. The properties of the alloys are achieved in part due to the elemental compositions of the alloys.

In some examples, the aluminum alloy for optional use as a core layer can have the following elemental composition as provided in Table 1.

TABLE 1

| Element | Weight Percentage (wt. %) |
|---|---|
| Si | 0.8-1.3 |
| Fe | Up to 0.6 |
| Cu | 0.1-0.6 |
| Mn | 0.9-2 |
| Mg | Up to 0.2 |
| Cr | Up to 0.3 |
| Zn | Up to 0.5 |
| Ti | Up to 0.2 |
| Zr | Up to 0.3 |
| Others | 0-0.05 (each) |
| | 0-0.15 (total) |

In some examples, the aluminum alloy for optional use as a core layer can have the following elemental composition as provided in Table 2.

TABLE 2

| Element | Weight Percentage (wt. %) |
|---|---|
| Si | 0.8-1.3 |
| Fe | Up to 0.6 |
| Cu | 0.1-0.6 |
| Mn | 0.9-2 |
| Mg | Up to 0.2 |
| Cr | Up to 0.25 |
| Zn | Up to 0.4 |
| Ti | Up to 0.2 |
| Zr | Up to 0.25 |
| Others | 0-0.05 (each) |
| | 0-0.15 (total) |

Remainder Al

In some examples, the aluminum alloy for optional use as a core layer can have the following elemental composition as provided in Table 3.

TABLE 3

| Element | Weight Percentage (wt. %) |
|---|---|
| Si | 0.8-1.3 |
| Fe | Up to 0.4 |
| Cu | 0.10-0.5 |
| Mn | 0.9-2.0 |
| Mg | Up to 0.1 |
| Cr | Up to 0.2 |
| Zn | Up to 0.3 |
| Ti | Up to 0.2 |
| Zr | Up to 0.2 |
| Others | 0-0.05 (each) |
| | 0-0.15 (total) |

Remainder Al

In some examples, the aluminum alloy for optional use as a core layer can have the following elemental composition as provided in Table 4.

TABLE 4

| Element | Weight Percentage (wt. %) |
|---|---|
| Si | 0.85-1.3 |
| Fe | Up to 0.55 |
| Cu | 0.10-0.55 |
| Mn | 1-2 |
| Mg | Up to 0.2 |
| Cr | Up to 0.15 |
| Zn | Up to 0.2 |
| Ti | Up to 0.15 |
| Zr | Up to 0.15 |
| Others | 0-0.05 (each) |
| | 0-0.15 (total) |

Remainder Al

In some examples, the aluminum alloy for optional use as a core layer can have the following elemental composition as provided in Table 5.

TABLE 5

| Element | Weight Percentage (wt. %) |
|---|---|
| Si | 0.85-1.25 |
| Fe | Up to 0.5 |
| Cu | 0.2-0.5 |
| Mn | 1.2-1.8 |
| Mg | Up to 0.15 |
| Cr | Up to 0.1 |
| Zn | Up to 0.1 |
| Ti | Up to 0.1 |
| Zr | Up to 0.1 |
| Others | 0-0.05 (each) |
| | 0-0.15 (total) |

Remainder Al

In some examples, the aluminum alloy for optional use as a core layer can have the following elemental composition as provided in Table 6.

TABLE 6

| Element | Weight Percentage (wt. %) |
|---|---|
| Si | 0.85-1.15 |
| Fe | Up to 0.38 |
| Cu | 0.23-0.43 |
| Mn | 1.4-1.6 |
| Mg | Up to 0.1 |
| Cr | Up to 0.05 |
| Zn | Up to 0.05 |
| Ti | Up to 0.1 |
| Zr | Up to 0.05 |
| Others | 0-0.05 (each) |
| | 0-0.15 (total) |

Remainder Al

In some examples, the aluminum alloy for optional use as a core layer can have the following elemental composition as provided in Table 7.

TABLE 7

| Element | Weight Percentage (wt. %) |
|---|---|
| Si | 0.9-1.1 |
| Fe | Up to 0.35 |
| Cu | 0.23-0.43 |
| Mn | 1.4-1.6 |
| Mg | Up to 0.05 |
| Cr | Up to 0.03 |
| Zn | Up to 0.04 |
| Ti | Up to 0.1 |
| Zr | Up to 0.01 |
| Others | 0-0.05 (each) |
| | 0-0.15 (total) |

Remainder Al

In some examples, the aluminum alloy for optional use as a core layer can have the following elemental composition as provided in Table 8.

TABLE 8

| Element | Weight Percentage (wt. %) |
|---|---|
| Si | 0.7-1.3 |
| Fe | Up to 0.6 |
| Cu | 0.1-0.6 |
| Mn | 0.9-2 |
| Mg | Up to 0.2 |
| Cr | Up to 0.25 |
| Zn | Up to 0.4 |
| Ti | Up to 0.2 |
| Zr | Up to 0.25 |
| Others | 0-0.05 (each) |
| | 0-0.15 (total) |

Remainder Al

In some examples, the aluminum alloy for optional use as a core layer can have the following elemental composition as provided in Table 9.

TABLE 9

| Element | Weight Percentage (wt. %) |
|---|---|
| Si | 0.7-1.3 |
| Fe | Up to 0.6 |
| Cu | 0.1-0.6 |
| Mn | 0.9-2 |
| Mg | Up to 0.2 |
| Cr | Up to 0.25 |
| Zn | Up to 0.4 |
| Ti | Up to 0.2 |
| Zr | Up to 0.25 |
| Others | 0-0.05 (each) |
| | 0-0.15 (total) |

Remainder Al

### Silicon (Si)

In some examples, the aluminum alloy includes silicon (Si) in an amount from 0.70% to 1.35% (e.g., from 0.70% to 1.3%, from 0.8% to 1.3%, from 0.85% to 1.3%, from 0.85% to 1.25%, from 0.85% to 1.2%, from 0.85% to 1.15%, or from 0.9% to 1.1%) based on the total weight of the alloy. For example, the aluminum alloy can include 0.70%, 0.71%, 0.72%, 0.73%, 0.74%, 0.75%, 0.77%, 0.78%, 0.79%, 0.80%, 0.81%, 0.82%, 0.83%, 0.84%, 0.85%, 0.86%, 0.87%, 0.88%, 0.89%, 0.90%, 0.91%, 0.92%, 0.93%, 0.94%, 0.95%, 0.96%, 0.97%, 0.98%, 0.99%, 1.00%, 1.01%, 1.02%, 1.03%, 1.04%, 1.05%, 1.06%, 1.07%, 1.08%, 1.09%, 1.10%, 1.11%, 1.12%, 1.13%, 1.14%, 1.15%, 1.16%, 1.17%, 1.18%, 1.19%, 1.20%, 1.21%, 1.22%, 1.23%, 1.24%, 1.25%, 1.26%, 1.27%, 1.28%, 1.29%, 1.30%, 1.31%, 1.32%, 1.33%, or 1.35% Si. All percentages are expressed in wt. %. As described above, Si can lower the solidus temperature of the aluminum alloy. The amount of Si is carefully balanced with Mn to provide an adequate solidus temperature for the aluminum alloy for brazing processes. Additionally, aluminum alloys having a Si content from 0.7% to 1.3% can utilize recycled aluminum alloy scrap containing higher amounts of Si. For example, the aluminum alloy described herein can be produced from higher Si containing aluminum alloy process scraps such as used clad aluminum alloy products containing a mixture of 3xxx series aluminum alloys and 4xxx series aluminum alloys. However, a higher level of Si (e.g., greater than 1.3 wt. %) increases the risk of erosion during brazing.

### Iron (Fe)

In some examples, the alloy also includes iron (Fe) up to 0.6% (e.g., up to 0.6, up to 0.55, up to 0.5, up to 0.45, up to 0.4, up to 0.38%, up to 0.35%, up to 0.3%, up to 0.25%, or up to 0.2%) based on the total weight of the alloy. For example, the alloy can include 0.01%, 0.02%, 0.03%, 0.04%, 0.05%, 0.60%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, or 0.60% Fe. In some cases, Fe is not present in the alloy (i.e., 0%). All percentages are expressed in wt. %.

### Copper (Cu)

In some examples, the disclosed alloy includes copper (Cu) in an amount from 0.1% to 0.6% (e.g., from 0.1% to 0.55%, from 0.1% to 0.5%, from 0.1% to 0.4%, from 0.15% to 0.45%, from 0.2% to 0.45%, from 0.2% to 0.4%, or from 0.23% to 0.43%) based on the total weight of the alloy. For example, the alloy can include 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, or 0.60% Cu. All percentages are expressed in wt. %. Cu addition can increase the electrochemical potential of an aluminum alloy (e.g., a core aluminum alloy) and thus can improve corrosion resistance.

### Manganese (Mn)

In some examples, the alloy can include manganese (Mn) in an amount from 0.9% to 2% (e.g., from 1% to 2%, from 1% to 1.9%, from 1.2% to 1.8%, or from 1.4% to 1.6%) based on the total weight of the alloy. For example, the alloy can include 0.90%, 0.91%, 0.92%, 0.93%, 0.94%, 0.95%, 0.96%, 0.97%, 0.98%, 0.99%, 1.00%, 1.01%, 1.02%, 1.03%, 1.04%, 1.05%, 1.06%, 1.07%, 1.08%, 1.09%, 1.10%, 1.11%, 1.12%, 1.13%, 1.14%, 1.15%, 1.16%, 1.17%, 1.18%, 1.19%, 1.20%, 1.21%, 1.22%, 1.23%, 1.24%, 1.25%, 1.26%, 1.27%, 1.28%, 1.29%, 1.30%, 1.31%, 1.32%, 1.33%, 1.34%, 1.35%, 1.36%, 1.37%, 1.38%, 1.39%, 1.40%, 1.41%, 1.42%, 1.43%, 1.44%, 1.45%, 1.46%, 1.47%, 1.48%, 1.49%, 1.50%, 1.51%, 1.52%, 1.53%, 1.54%, 1.55%, 1.56%, 1.57%, 1.58%, 1.59%, 1.60%, 1.61%, 1.62%, 1.63%, 1.64%, 1.65%, 1.66%, 1.67%, 1.68%, 1.69%, 1.70%, 1.71%, 1.72%, 1.73%, 1.74%, 1.75%, 1.76%, 1.77%, 1.78%, 1.79%, 1.80%, 1.81%, 1.82%, 1.83%, 1.84%, 1.85%, 1.86%, 1.87%, 1.88%, 1.89%, 1.90%, 1.91%, 1.92%, 1.93%, 1.94%, 1.95%, 1.96%, 1.97%, 1.98%, 1.99%, or 2.00% Mn. All percentages are expressed in wt. %. As described above, Mn can increase the solidus temperature of the aluminum alloy. Mn is added to the aluminum alloy composition to compensate for the higher amounts of Si and Cu in the aluminum alloy composition. Additionally, Mn largely remains in solid solution while a small amount is precipitated during hot rolling and inter-annealing as fine dispersoids. The effect of this microstructure is that, when the material is heated to 600° C. as in a brazing operation, the material retains strength due to the solid solution strengthening effects of the Mn. In this way the addition of Mn is optimized to provide a useful balance of properties. Another positive effect of Mn is the formation of fine dispersoids to control the grain structure of the brazed heat exchanger or the brazing sheet itself.

### Magnesium (Mg)

In some examples, the alloy can include magnesium (Mg) in an amount up to 0.2% (e.g., up to 0.15%, up to 0.1%, up to 0.08%, up to 0.05%, or up to 0.03%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, or 0.20% Mg. In some cases, Mg is not present in the alloy (i.e., 0%). All percentages are expressed in wt. %. The Mg content in aluminum alloys can affect the amount of flux needed during the CAB process. Aluminum alloys that include high amounts of Mg (e.g., greater than 0.2 wt. %) require higher flux loads. However, higher flux loads result in higher amounts of flux residues after brazing. Flux residues can also cause uneven painting and/or poor adherence during lacquering. Beneficially, the aluminum alloy includes 0.2 wt. % or less of Mg for brazing with lower flux loads to minimize or reduce the amount of the flux residue.

### Chromium (Cr)

In some examples, the alloy includes chromium (Cr) in an amount up to 0.3% (e.g., from 0.001% to 0.3%, from 0.01% to 0.25%, from 0.05% to 0.2%, from 0.001% to 0.04%, from 0% to 0.05%, from 0.001% to 0.04%, or from 0.01% to 0.03%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, or 0.30% Cr. In some cases, Cr is not present in the alloy (i.e., 0%). All percentages are expressed in wt. %.

### Zinc (Zn)

In some examples, the alloy includes zinc (Zn) in an amount up to 0.5% (e.g., from 0.001% to 0.5%, from 0.001% to 0.4%, from 0.001% to 0.3%, from 0.01% to 0.2%, from 0% to 0.15%, from 0% to 0.1%, or from 0% to 0.03%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, or 0.50% Zn. In some cases, Zn is not present in the alloy (i.e., 0%).

### Titanium (Ti)

In some examples, the alloy includes titanium (Ti) in an amount up to 0.2% (e.g., from 0% to 0.15%, from 0.001% to 0.1%, from 0% to 0.05%, from 0.001% to 0.04%, or from 0.01% to 0.03%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, or 0.20% Ti. In some cases, Ti is not present in the alloy (i.e., 0%). All percentages are expressed in wt. %.

### Zirconium (Zr)

In some examples, the alloy includes zirconium (Zr) in an amount up to 0.3% (e.g., from 0% to 0.25%, from 0.001% to 0.2%, from 0.01% to 0.15%, from 0.01% to 0.1%, from 0% to 0.05%, from 0.001% to 0.04%, or from 0.01% to 0.03%) based on the total weight of the alloy. For example, the alloy can include 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, or 0.30% Zr. In some cases, Zr is not present in the alloy (i.e., 0%). All percentages are expressed in wt. %.

Optionally, the alloy compositions can further include other minor elements, sometimes referred to as impurities, in amounts of 0.05% or below, 0.04% or below, 0.03% or below, 0.02% or below, or 0.01% or below each. These impurities may include, but are not limited to, Na, Ga, V, Ni, Sc, Ag, B, Bi, Li, Pb, Sn, Ca, Hf, Sr, or combinations thereof. Accordingly, Na, Ga, V, Ni, Sc, Ag, B, Bi, Li, Pb, Sn, Ca, Hf, or Sr may be present in an alloy in amounts of 0.05% or below, 0.04% or below, 0.03% or below, 0.02% or below, or 0.01% or below. In certain aspects, the sum of all impurities does not exceed 0.15% (e.g., 0.1%). All percentages are expressed in wt. %. In certain aspects, the remaining percentage of the alloy is aluminum.

In some embodiments, an exemplary alloy includes 0.85%-1.15% Si, up to 0.38% Fe, 0.23%-0.43% Cu, 1.40%-1.60% Mn, up to 0.1% Mg, up to 0.03% Cr, up to 0.04% Zn, up to 0.1% Ti, up to 0.01% Zr, and up to 0.15% total impurities, with the remainder as Al. All percentages are expressed in wt. %.

In some embodiments, an exemplary alloy includes 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

In some embodiments, an exemplary alloy includes 0.7-1.3 wt. % Si, up to 0.6 wt. % Fe, 0.1-0.6 wt. % Cu, 0.9-2 wt. % Mn, up to 0.2 wt. % Mg, up to 0.25 wt. % Cr, up to 0.4 wt. % Zn, up to 0.2 wt. % Ti, up to 0.25 wt. % Zr, up to 0.15 wt. % of impurities, and remainder Al.

In some embodiments, an exemplary alloy includes 0.7-1.3 wt. % Si, up to 0.4 wt. % Fe, 0.1-0.5 wt. % Cu, 0.9-2 wt. % Mn, up to 0.1 wt. % Mg, up to 0.2 wt. % Cr, up to 0.3 wt. % Zn, up to 0.2 wt. % Ti, up to 0.2 wt. % Zr, up to 0.15 wt. % of impurities, and remainder Al.

In some embodiments, an exemplary alloy includes 0.7-1.3 wt. % Si, up to 0.55 wt. % Fe, 0.1-0.55 wt. % Cu, 1-2 wt. % Mn, up to 0.2 wt. % Mg, up to 0.15 wt. % Cr, up to 0.2 wt. % Zn, up to 0.15 wt. % Ti, up to 0.15 wt. % Zr, up to 0.15 wt. % of impurities, and remainder Al.

In some embodiments, an exemplary alloy includes 0.7-1.25 wt. % Si, up to 0.5 wt. % Fe, 0.2-0.5 wt. % Cu, 1.2-1.8 wt. % Mn, up to 0.15 wt. % Mg, up to 0.10 wt. % Cr, up to 0.10 wt. % Zn, up to 0.1 wt. % Ti, up to 0.1 wt. % Zr, up to 0.15 wt. % of impurities, and remainder Al.

In some embodiments, an exemplary alloy includes 0.7-1.15 wt. % Si, up to 0.38 wt. % Fe, 0.23-0.43 wt. % Cu, 1.4-1.6 wt. % Mn, up to 0.1 wt. % Mg, up to 0.05 wt. % Cr, up to 0.05 wt. % Zn, up to 0.1 wt. % Ti, up to 0.05 wt. % Zr, up to 0.15 wt. % of impurities, and remainder Al.

### Cladding Layer

In some embodiments, the cladding layer is a 1xxx, 3xxx, 4xxx, or 7xxx series aluminum alloy.

In some embodiments, the cladding layer is a 4xxx series aluminum alloy. The 4xxx series aluminum alloy may include from 1 wt. % to 15 wt. % Si. Suitable 4xxx series aluminum alloys for use in the cladding layer described herein include, for example, AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, AA4147, and modifications thereof.

### Recycled Aluminum Alloy Materials for Core Alloy

The aluminum alloys described herein can tolerate high amounts of recycled aluminum alloy materials and substantially reduce Scope 3 emission as further defined below. The impact of the impurities and/or alloying elements (from recycled aluminum alloy materials) on the mechanical properties of the aluminum alloy is reduced by providing a tailored aluminum alloy composition to compensate for the impurities. This enables a higher impurity recycled aluminum alloy materials (e.g., used clad aluminum alloy products including 3xxx/4xxx series aluminum alloy) for producing aluminum alloys that can still exhibit desirable properties.

The net greenhouse gas emission of an entity is often measured in equivalent units of CO₂ and referred to as an entity's “carbon footprint”. An entity's carbon footprint is believed to be a representative measure of that entity's impact on the environment vis-à-vis the concentration of GHG in the atmosphere. Entities that undertake initiatives to reduce their carbon footprint are often deemed to be socially responsible, and are therefore often labeled as being “green” or environmentally friendly. As used herein, the term CO₂ implies and is meant to include all types of GHG emissions.

There are a number of basic components to consider in making a determination of, or in attempting to measure an entity's carbon footprint. Of primary concern are operational effects, in which emissions arising from the activities undertaken by the entity itself (and other emitting entities it has ownership or control of) are considered. There are also upstream and downstream effects which may also be taken into account in determining an entity's net emissions. For the purposes of accurate ‘carbon accounting’, the operational activities of the entity may be further subdivided into direct GHG emissions and indirect GHG emissions.

Direct operational emissions are defined as having occurred from sources that are owned or controlled by the entity, including, for example, emissions from combustion in owned boilers or vehicles. For the purposes of compiling emissions data reports for carbon auditing and regulatory submission, an entity's direct emissions are often collectively referred to as Scope 1 emissions by those of skill in the art. These emissions can be measured accurately utilizing equations which may require, for example, knowledge of mass/volume of fuel burned per unit time and knowledge of how the fuel was burned.

An entity's Scope 1 emissions can be affected by many factors, including such things as the manner in which factories are operated or goods are transported within and by the company. For example, a company using hybrid vehicles to transport its goods rather than traditional internal-combustion-only vehicles may be deemed to have reduced its carbon footprint by a certain degree. Likewise, companies who have undertaken efforts to reduce their factory emissions, for example by using on-site renewable heat sources such as solar thermal paneling, will also have a smaller carbon footprint than companies that have not engaged in such efforts.

Indirect operational emissions are defined as having resulted from the generation of the electricity consumed by the entity. These emissions occur physically at the facility where electricity is generated by the entity's supplier and are often collectively referred to as Scope 2 emissions by those of skill in the art. These emissions also can be calculated with a high degree of accuracy using knowledge of the amount of electricity used in a particular time period (for instance in Megawatt-Hours), and then using the ‘emissions factor’ relating to a particular power supplier and specified tariff.

These Scope 2 emissions will be decreased proportionally if the entity chooses an electricity supply tariff that includes a component of renewable energy. Likewise, emissions may be reduced if the entity is able to reduce its need to import electricity from an outside supplier by such methods as improving energy efficiency, or developing on-site renewable power sources such as solar photovoltaic panels.

A range of other emissions relating to an entity's activities may also be considered in calculating its net carbon footprint. These will vary by industry sector and sub-sector and are often referred to as Scope 3 emissions. They may include emissions resulting from such activities as employee travel, and travel to the entity's premises of downstream consumers. Both upstream and downstream suppliers of the entity's value chain may be considered in estimating Scope 3 emissions. This may be important, for instance because the ‘carbon-intense’ parts of the value chain might be performed by a third party rather than by the entity under consideration, but still arise as a result of the entity's business. An example of the latter would be an online mail-order firm which, having a small warehouse and office, might cause low direct/indirect emissions itself, but subcontracts a delivery firm with a fleet of trucks and high emissions. The downstream effects factor may also be affected by a plethora of other factors which are likely to vary from industry to industry.

The aluminum alloy described herein includes less primary aluminum than conventional 3xxx series aluminum alloys, thereby lowering Scope 3 Emissions during aluminum alloy production to reduce the overall carbon footprint. In order to reduce the amount of primary aluminum and include high amounts of recycled aluminum alloy materials, the aluminum alloy composition is carefully tailored to provide a balance of mechanical properties. For example, FIG. 1 provides an example of a phase diagram of the solidus temperature of an aluminum alloy as a function of the Si concentration in the aluminum alloy. Si is one type of common alloying element in some recycled aluminum alloy materials that can affect mechanical properties if used to produce new aluminum alloys. As shown in FIG. 1, if an aluminum alloy is produced from recycled aluminum materials including a high concentration of Si, the solidus temperature of the aluminum alloy produced from these recycled materials can be substantially lower than 600° C. Aluminum alloys having a solidus temperature less than 600° C. may be susceptible to local melting and cannot be used to produce core aluminum alloys. Therefore, the types and amounts of recycled aluminum alloy material that can be used to produce core aluminum alloys is limited based on the amount of Si.

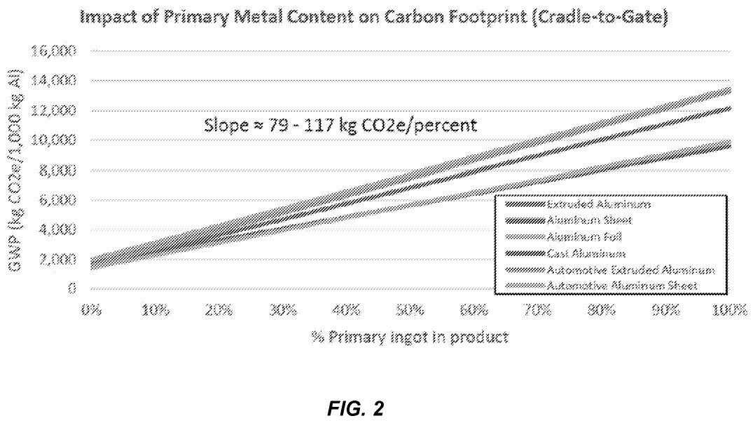

The aluminum alloy compositions described herein can include higher amounts of recycled aluminum alloy materials to reduce the overall carbon footprint of the aluminum alloy compared to conventional 3xxx series aluminum alloys. Aluminum alloys produced from recycled aluminum alloys with little to no primary aluminum minimize potential environmental impacts. Although primary aluminum may only comprise a small share of the raw material input in many aluminum alloys, it nevertheless contributes significantly to the environmental impact for many aluminum alloy products. Given the significant influence of primary aluminum on the carbon footprint, one way to lower Scope 3 emissions (as defined above) during aluminum alloy production is to reduce the use of primary aluminum and increase the use of recycled aluminum alloy materials. For example, FIG. 2 shows that a 1% increase in primary aluminum will increase the carbon footprint of an aluminum alloy by as much as 117 kgCO2e for 1,000 kg of product produced. Therefore, a 1% increase in recycled aluminum alloy materials used to produce an aluminum alloy will lead to a reduction of carbon footprint by the same amount. Although there are aluminum alloys available on the market that can incorporate higher amounts of recycled aluminum alloy materials that allow higher contents for certain critical elements (e.g., Mg, Si, Cu, and Mn), these aluminum alloys cannot be considered for critical parts in heat exchangers (e.g., corrosion critical parts). For these critical parts, tighter chemistry tolerances may be needed for desired properties.

In some embodiments, the aluminum alloys described herein provide a composition that is well-suited for utilizing used clad aluminum alloy products as recycle material. Specifically, the aluminum alloys described herein can be produced from a substantial portion of used clad aluminum alloy products including a mixture of 3xxx and 4xxx series aluminum alloy. The aluminum alloy composition for the core alloy described herein includes a balance of Si, Cu, and Mn that provides a solidus temperature greater than 600° C. The Mn in the aluminum alloy composition compensates for the Si and Cu to produce an aluminum alloy having a desirable solidus temperature for brazing application.

In some embodiments, used clad aluminum alloy products comprising a mixture of the 3xxx and 4xxx series aluminum alloy can be used as recycle material. As discussed herein, the aluminum alloy composition can utilize recycled aluminum alloy materials (e.g., used clad aluminum alloy products) to produce the aluminum alloy due to the aluminum alloy composition. The aluminum alloy can be produced with higher volumes of recycled aluminum alloy materials and reduced amounts of primary aluminum. In some embodiments, the aluminum alloy composition described herein can be produced from a mixture of 3xxx series and 4xxx series aluminum alloys. In some aspects, the aluminum alloys described herein include an amount of recycled aluminum alloy materials at or greater than 50%, e.g., at or greater than 52%, at or greater than 54%, at or greater than 56%, at or greater than 58%, at or greater than 60%, at or greater than 62%, at or greater than 64%, or at or greater than 65%. As discussed above, in some aspects the aluminum alloys described herein are particularly well-suited to utilize a mixture of 3xxx series aluminum alloy scrap and 4xxx series aluminum alloy scrap.

In some aspects, the aluminum alloys described herein include less than 50% primary aluminum, e.g., less than 45%, less than 40%, less than 35%, less than 30%, less than 29%, less than 28%, less than 27%, less than 26%, less than 25%, less than 24%, less than 23%, less than 22%, less than 21%, or less than 20%. All are expressed in wt. %.

### Alloy Properties of Core Alloy

In some embodiments, the solidus temperature of the aluminum alloy for use as a core alloy is important for controlling the properties for a brazed product. The solidus temperature refers to a temperature at which the aluminum alloy, in this case, the core layer, begins to melt (i.e., the onset of melting). The core layer described herein has a solidus temperature which avoids local melting during brazing. If the solidus temperature of the core layer is low (e.g., less than 600° C.), the core alloy may be susceptible to local melting. In some embodiments, the solidus temperature of the core layer is 600° C. or greater (e.g., 602° C. or greater, 604° C. or greater, 606° C. or greater, 608° C. or greater, or 610° C. or greater).

In certain aspects, the aluminum alloys described herein can have a yield strength from 30 MPa to 150 MPa in an O-temper (e.g., from 30 MPa to 125 MPa, from 30 MPa to 100 MPa, from 35 MPa to 80 MPa, from 40 MPa to 80 MPa, or from 50 MPa to 80 MPa). In certain aspects, the aluminum alloys described herein can have a yield strength of 30 MPa, 40 MPa, 50 MPa, 60 MPa, 70 MPa, 80 MPa, 90 MPa, 100 MPa, 110 MPa, 120 MPa, 130 MPa, 140 MPa, 150 MPa, or anywhere in between, in an O-temper.

In certain aspects, the aluminum alloys described herein can have an ultimate tensile strength from 100 MPa to 250 MPa in an O-temper (e.g., from 110 MPa to 240 MPa, from 120 MPa to 225 MPa, from 125 MPa to 200 MPa, from 130 MPa to 200 MPa, or from 150 MPa to 200 MPa). In some aspects, the aluminum alloys described herein can have a yield strength of 100 MPa, 110 MPa, 120 MPa, 130 MPa, 140 MPa, 150 MPa, 160 MPa, 170 MPa, 180 MPa, 190 MPa, 200 MPa, 210 MPa, 220 MPa, 230 MPa, 240 MPa, 250 MPa, or anywhere in between, in an O-temper.

In certain aspects, the aluminum alloys described herein can have sufficient formability to meet an elongation of at least 15% in an O-temper (e.g., at least 16%, at least 17%, at least 18%, at least 19%, or at least 20%).

### Methods of Preparing and Processing

In certain aspects, the disclosed alloy composition is a product of a disclosed method. Without intending to limit the disclosure, aluminum alloy properties are partially determined by the formation of microstructures during the alloy's preparation. In certain aspects, the method of preparation for an alloy composition may influence or even determine whether the alloy will have properties adequate for a desired application.

### Casting

The alloy described herein can be cast using a casting method as known to those of skill in the art. For example, the casting process can include a direct chill (DC) casting process. The DC casting process is performed according to standards commonly used in the aluminum industry as known to one of skill in the art. The DC process can provide an ingot. Optionally, the casting process can be a continuous casting (CC) process or an Electromagnetic casting (EMC) process. In some embodiments, the ingot can be scalped after casting and before downstream processing. In some embodiments, the casting process can include an electromagnetic casting (EMC) process.

The cast aluminum alloy can then be subjected to further processing steps. For example, the processing methods as described herein can include the steps of optional homogenization, preheating, hot rolling, cold rolling, slitting and/or annealing.

### Homogenization

In some embodiments, the method may include an optional homogenization step. In some embodiments, the homogenization step can be used in lieu of the preheating step. In some embodiments, the homogenization step can be used in combination with the preheating step. For example, the cast aluminum alloy can be homogenized and then subjected to preheating.

The homogenization step can include heating a cast aluminum alloy as described herein to attain a homogenization temperature of at least 500° C. (e.g., 500° C., 510° C., 520° C., 530° C., 540° C., 550° C., 560° C., 570° C., 580° C., 580° C., 590° C., 600° C., 610° C., 620° C., 630° C., or anywhere in between). For example, the cast aluminum alloy can be heated to a temperature of from 500° C. to 630° C., 510° C. to 615° C., 500° C. to 575° C., 510° C. to 600° C., or from 525° C. to 625° C. In some cases, the heating rate to the homogenization temperature can be 10° C./hour or greater, 20° C./hour or greater, 30° C./hour or greater, 40° C./hour or greater, 50° C./hour or greater, 60° C./hour or greater, or 70° C./hour or greater. In other cases, the heating rate to the homogenization temperature can be from 10° C./min to 100° C./min (e.g., 10° C./min to 90° C./min, 20° C./min to 80° C./min, 30° C./min to 70° C./min, from 40° C./min to 65° C./min, from 45° C./min to 60° C./min, or from 50° C./min to 60° C./min).

The cast aluminum alloy is then allowed to soak (i.e., held at the indicated temperature) for a period of time at the homogenization temperature range. According to one non-limiting example, the cast aluminum alloy is allowed to soak for up to 30 hours (e.g., from 10 minutes to 30 hours, inclusively). For example, the cast aluminum alloy can be soaked at a temperature from 500° C. to 630° C. for 10 minutes, 30 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, or anywhere in between.

### Preheating

The preheating step can include heating a cast aluminum alloy as described herein to attain a preheating temperature of at least 350° C. (e.g., 360° C., 370° C., 380° C., 390° C., 400° C., 410° C., 420° C., 430° C., 440° C., 450° C., 460° C., 470° C., 480° C., 490° C., 500° C., 510° C., 520° C., 530° C., 540° C., 550° C., 560° C., 570° C., 580° C., 580° C., 590° C., 600° C., 610° C., 620° C., 630° C., or anywhere in between). For example, the cast aluminum alloy can be heated to a temperature of from 350° C. to 630° C., 360° C. to 620° C., 375° C. to 610° C., 400° C. to 600° C., 410° C. to 575° C., from 420° C. to 550° C., from 440° C. to 540° C., from 450° C. to 530° C., or from 450° C. to 480° C. In some cases, the heating rate to the preheating temperature can be 10° C./hour or greater, 20° C./hour or greater, 30° C./hour or greater, 40° C./hour or greater, 50° C./hour or greater, 60° C./hour or greater, or 70° C./hour or greater. In other cases, the heating rate to the preheating temperature can be from 10° C./min to 100° C./min (e.g., 10° C./min to 90° C./min, 20° C./min to 80° C./min, 30° C./min to 70° C./min, from 40° C./min to 65° C./min, from 45° C./min to 60° C./min, or from 50° C./min to 60° C./min).

The cast aluminum alloy is then allowed to soak (i.e., held at the indicated temperature) for a period of time at the preheating temperature range. According to one non-limiting example, the cast aluminum alloy is allowed to soak for up to 30 hours (e.g., from 10 minutes to 30 hours, inclusively). For example, the cast aluminum alloy can be soaked at a temperature from 450° C. to 560° C. for 10 minutes, 30 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, or anywhere in between. In some embodiments, the cast aluminum alloy is soaked at a preheating temperature from 480° C. to 560° C. for 5 hours to 7 hours.

### Hot Rolling

Following the homogenization step and/or preheating step, a hot rolling step can be performed. The cast aluminum alloy can be hot rolled at a temperature from 350° C. to 560° C. (e.g., from 375° C. to 550° C., from 400° C. to 540° C., from 425° C. to 530° C., from 450° C. to 530° C., or from 475° C. to 520° C.). In some examples, the hot rolling temperature is 350° C., 360° C., 370° C., 380° C., 390° C., 400° C., 410° C., 420° C., 430° C., 440° C., 450° C., 460° C., 470° C., 480° C., 490° C., 500° C., 510° C., 520° C., 530° C., 540° C., 550° C. or 560° C. If the hot rolling temperature is too cold (e.g., less than 350° C.), the hot roll loads are too high and may be susceptible to cracking. If the hot rolling temperature is too hot (e.g., greater than 560° C.), the aluminum alloy may be too soft and break up in the hot rolling mill. In some embodiments, the cast aluminum alloy can be hot rolled at a temperature from 350° C. to 500° C.

In certain cases, the cast aluminum alloy can be hot rolled to a 2 mm to 15 mm thick gauge (e.g., from 2.5 mm to 12 mm thick gauge). For example, the cast aluminum alloy can be hot rolled to an 2 mm thick gauge, 2.5 mm thick gauge, 3 mm thick gauge, 3.5 mm thick gauge, 4 mm thick gauge, 5 mm thick gauge, 6 mm thick gauge, 7 mm thick gauge, 8 mm thick gauge, 9 mm thick gauge, 10 mm thick gauge, 11 mm thick gauge, 12 mm thick gauge, 13 mm thick gauge, 14 mm thick gauge, or 15 mm thick gauge. In certain cases, the cast aluminum alloy can be hot rolled to a gauge greater than 15 mm (i.e., a plate). In other cases, the cast aluminum alloy can be hot rolled to a gauge less than 4 mm (i.e., a sheet).

### Cold Rolling

Following the hot rolling step, an optional cold rolling step can be performed. The cold rolling step can include one or more cold rolling passes. In certain embodiments, the hot rolled product from the hot rolling step can be cold rolled to produce, for example, a thin-gauge shate or a sheet. In some embodiments, this thin-gauge shate or sheet is cold rolled to have a final gauge thickness (i.e., a first thickness) ranging from 0.02 mm to 10.0 mm (e.g., from 0.2 mm to 3 mm). In some embodiments, the cold rolling step can include two more cold rolling steps. The two or more cold rolling steps can reduce the thickness successively to the final gauge thickness.

Slitting and/or Annealing

Optionally, the method can further comprise intermittent and/or final annealing steps in between or after the cold rolling step. In some embodiments, the thin-gauge shate or sheet can be subjected to final annealing. In some embodiments, the final anneal step is a continuous anneal and solution heat treatment step. The thin-gauge shate or sheet may be heated to a peak metal temperature ranging from about 500° C. to 580° C. (e.g., 500° C., 510° C., 520° C., 530° C., 540° C., 550° C., 560° C., 570° C., or 580° C.) and soaked (i.e., held at the indicated temperature) for a period of time above a predetermined temperature. In some examples, the thin-gauge shate or sheet is allowed to soak for up to about 10 minutes (e.g., from 1 second to 10 minutes, inclusively). For example, the sheet can be soaked for about 5 seconds or less, 10 seconds or less, 15 seconds or less, 30 seconds or less, 45 seconds or less, 1 minute or less, 2 minutes or less, 3 minutes or less, 4 minutes or less, 5 minutes or less, 6 minutes or less, 7 minutes or less, 8 minutes or less, 9 minutes or less, or 10 minutes or less.

In some embodiments, the method can optionally comprise a slitting step. The thin-gauge shate or sheet can be subjected to slitting after cold rolling or final annealing. In some embodiments, the thin-gauge shate or sheet can be slit a final thickness or slit to provide multiple narrower widths/rings/coils before or after final annealing.

### Methods of Brazing

The clad aluminum alloy products described herein are suitable for brazing applications. Accordingly, various brazing processes and technological steps can be suitably employed in the embodiments of the present disclosure. The clad aluminum alloy products can be brazed in an inert gas atmosphere. Any suitable inert gas may be employed including, for example, argon, helium, nitrogen, etc. The clad aluminum alloy products described herein are suitable for CAB. For the brazing cycle, the clad aluminum alloy products can be heated in a CAB furnace. In some embodiments, the aluminum alloys can be used in other joining processes, such as, vacuum brazing, flame brazing, fluxed braze rings/shims, inductive heating, laser brazing, welding, adhesive bonding among others.

In some embodiments, the surface of the metal part to be joined to the clad aluminum alloy product is prepared (e.g., pretreatment) before brazing. In some embodiments, the metal part to be joined is subjected to one or more pretreatments which can be used to promote adhesion of the clad aluminum alloy product and the metal part. The adhesion of the clad aluminum alloy product to the metal part, for example the cladding layer of a clad aluminum alloy product, may be improved by pretreating the outer surface of the metal part on which the clad aluminum alloy product is being deposited to produce good braze joints. In some embodiments, the pretreatment includes a preliminary cleaning step during which the surface of the metal part is treated to remove grease, oil, buffing compounds, rolling lubricants or slitting oils. This can be accomplished in many ways, for example by thermal degreasing, solvent washing, solvent emulsion cleaning, mechanical grinding, or by mild etching.

In some embodiments, the surface of the metal part to be joined is etched to remove residual traces of oil and grease from rolling processes and to make the oxide film layer thinner. For example, the preparation process involves etching the surface of the metal part using a caustic cleaner (e.g., 10% NaOH) to remove all traces of oil or grease. In some embodiments, etching the surface can produce surface characteristics that are important to form a good braze joint.

In some embodiments, the brazing process is carried out in a dry atmosphere with little or no oxygen in the atmosphere. In some embodiments, the brazing process is carried out in an inert atmosphere of nitrogen, argon, or helium. The brazing process can include heating the clad aluminum alloy products as described herein to attain a brazing temperature of about, or at least about, 560° C. (e.g., at least 570° C., at least 580° C., at least 590° C., at least 600° C., or anywhere in between). For example, the clad aluminum alloy product can be heated to a temperature of from 560° C. to 620° C., from 570° C. to 615° C., from 580° C. to 610° C., or from 590° C. to 605° C. In some cases, the heating rate to the brazing temperature can be 200° C./hour or less, 180° C./hour or less, 160° C./hour or less, 140° C./hour or less, 120° C./hour or less, 100° C./hour or less, 75° C./hour or less, 50° C./hour or less, 40° C./hour or less, 30° C./hour or less, 25° C./hour or less, 20° C./hour or less, 15° C./hour or less, or 10° C./hour or less. In other cases, the heating rate to the brazing temperature can be from 10° C./min to 200° C./min (e.g., 10° C./min to 175° C./min, 10° C./min to 150° C./min, 10° C./min to 100° C./min, from 20° C./min to 90° C./min, from 30° C./min to 80° C./min, from 40° C./min to 70° C./min, or from 50° C./min to 60° C./min). In some embodiments, the heating rate to peak temperature in the CAB furnace is less than 3 minutes.

In some embodiments, the clad aluminum alloy products can be heated in the CAB furnace at a rate of 100° C. per minute until a temperature of 520° C. is reached. The clad aluminum alloy products can then be heated at a rate of 25° C. per minute until a temperature of 605° C. is reached, followed by a 3-minute heat soak at 605° C. The clad aluminum alloy products can then be cooled to 570° C., and removed from the furnace to cool at room temperature. In some embodiments, the clad aluminum alloy product is heated for 3 minutes at 600° C. in a CAB furnace under the brazing atmosphere in which the oxygen concentration is less than 100 ppm and dew point is less than −40° C. (in a nitrogen atmosphere).

In some embodiments, a method of manufacturing an article, such as a heat exchanger, joined by brazing or an assembly of brazed components is provided. The method may include providing the components of which at least one is made from a clad aluminum alloy product described herein. The method may include assembling the components, such as corrugated fin stock material and other components such as tubes, into an assembly. The method may further include brazing the assembly without applying a brazing flux on the assembly of components. The whole assembly is brazed in a controlled inert gas atmosphere at a brazing temperature, typically at a temperature in a range of 560° C. to 620° C. for a period long enough for melting and spreading of a filler joining the various components, e.g., a dwell time of 1 to 5 minutes. The oxygen content in the brazing atmosphere should be as low as reasonably possible, and is preferably below 100 ppm, and more preferably below 50 ppm, for example at 25 ppm or less. The method further includes cooling of the brazed assembly, typically to below 100° C., e.g., to room temperature using, for example, blown air or any other suitable cooling medium.

While metal parts such as aluminum alloy articles are described throughout the text, the methods and articles apply to any metal. In some examples, the metal part is aluminum, an aluminum alloy, magnesium, a magnesium-based material, titanium, a titanium-based material, copper, a copper-based material, steel, a steel-based material, bronze, a bronze-based material, brass, a brass-based material, a composite, a sheet used in composites, or any other suitable metal or combination of materials.

### Methods of Using

The aluminum alloys and methods described herein can be used in industrial applications including sacrificial parts, heat dissipation, heating, ventilation, air conditioning and refrigeration, packaging and building materials. The aluminum alloys described herein can be used in various applications, for example, for manufacturing fins for heat exchangers. In one example, the improved aluminum alloys described herein are useful for high performance, light weight automotive heat exchangers. More generally, the aluminum alloys described herein can be used in motor vehicle heat exchangers such as radiators, condensers, heaters, intercoolers, charge air coolers, oil coolers, exhaust coolers, fuel coolers, cold plates (also called e.g., cooling plates or battery cooling plates) and evaporators. Cold plates are typically produced by brazing a bare aluminum flat sheet to a formed sheet with a clad liner on one side and possible a 1xxx or a 7xxx sacrificial liner on the other side (e.g., coolant channel side). The aluminum alloys described could be used for the bare flat sheet and/or as core alloy for the formed sheet. As discussed above, the compositions and the processes for producing the improved aluminum alloys described herein lead to a material possessing a combination of beneficial characteristics and properties that make it suitable for manufacturing cold plates, base plates, tubes, headers, manifolds, side supports or other parts of automotive or industrial heat exchangers. However, the uses and applications of the improved aluminum alloys described herein are not limited to automotive or industrial heat exchangers and other uses are envisioned. The improved aluminum alloys described herein can be used for manufacture of various devices employing heat exchangers and produced by brazing, such as devices employed in heating, ventilation, and air conditioning (HVAC).

The aluminum alloys disclosed herein are suitable substitutes for metals conventionally used in indoor and outdoor HVAC units. As used herein, the meaning of “indoor” refers to a placement contained within any structure produced by humans with controlled environmental conditions. As used herein, the meaning of “outdoor” refers to a placement not fully contained within any structure produced by humans and exposed to geological and meteorological environmental conditions comprising air, solar radiation, wind, rain, sleet, snow, freezing rain, ice, hail, dust storms, humidity, aridity, smoke (e.g., tobacco smoke, house fire smoke, industrial incinerator smoke and wild fire smoke), smog, fossil fuel exhaust, bio-fuel exhaust, salts (e.g., high salt content air in regions near a body of salt water), radioactivity, electromagnetic waves, corrosive gases, corrosive liquids, galvanic metals, galvanic alloys, corrosive solids, plasma, fire, electrostatic discharge (e.g., lightning), biological materials (e.g., animal waste, saliva, excreted oils, vegetation), wind-blown particulates, barometric pressure change, and diurnal temperature change. The aluminum alloys described herein provide better corrosion performance and higher strength as compared to alloys currently employed.

The following examples will serve to further illustrate the present invention without, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. During the studies described in the following examples, conventional procedures were followed, unless otherwise stated. Some of the procedures are described below for illustrative purposes.

### Illustrations

Illustration 1: An aluminum alloy comprising 0.8-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

Illustration 2: The illustration of any preceding or subsequent illustration, comprising 0.8-1.3 wt. % Si, up to 0.6 wt. % Fe, 0.1-0.6 wt. % Cu, 0.9-2 wt. % Mn, up to 0.2 wt. % Mg, up to 0.25 wt. % Cr, up to 0.4 wt. % Zn, up to 0.2 wt. % Ti, up to 0.25 wt. % Zr, up to 0.15 wt. % of impurities, and remainder Al.

Illustration 3: The illustration of any preceding or subsequent illustration, comprising 0.8-1.3 wt. % Si, up to 0.4 wt. % Fe, 0.1-0.5 wt. % Cu, 0.9-2 wt. % Mn, up to 0.1 wt. % Mg, up to 0.2 wt. % Cr, up to 0.3 wt. % Zn, up to 0.2 wt. % Ti, up to 0.2 wt. % Zr, up to 0.15 wt. % of impurities, and remainder Al.

Illustration 4: The illustration of any preceding or subsequent illustration, comprising 0.85-1.3 wt. % Si, up to 0.55 wt. % Fe, 0.1-0.55 wt. % Cu, 1-2 wt. % Mn, up to 0.2 wt. % Mg, up to 0.15 wt. % Cr, up to 0.2 wt. % Zn, up to 0.15 wt. % Ti, up to 0.15 wt. % Zr, up to 0.15 wt. % of impurities, and remainder Al.

Illustration 5: The illustration of any preceding or subsequent illustration, comprising 0.85-1.25 wt. % Si, up to 0.5 wt. % Fe, 0.2-0.5 wt. % Cu, 1.2-1.8 wt. % Mn, up to 0.15 wt. % Mg, up to 0.10 wt. % Cr, up to 0.10 wt. % Zn, up to 0.1 wt. % Ti, up to 0.1 wt. % Zr, up to 0.15 wt. % of impurities, and remainder Al.

Illustration 6: The illustration of any preceding or subsequent illustration, comprising 0.85-1.15 wt. % Si, up to 0.38 wt. % Fe, 0.23-0.43 wt. % Cu, 1.4-1.6 wt. % Mn, up to 0.1 wt. % Mg, up to 0.05 wt. % Cr, up to 0.05 wt. % Zn, up to 0.1 wt. % Ti, up to 0.05 wt. % Zr, up to 0.15 wt. % of impurities, and remainder Al.

Illustration 7: The illustration of any preceding or subsequent illustration, comprising 0.9-1.1 wt. % Si, up to 0.35 wt. % Fe, 0.23-0.43 wt. % Cu, 1.4-1.6 wt. % Mn, up to 0.05 wt. % Mg, up to 0.03 wt. % Cr, up to 0.04 wt. % Zn, up to 0.1 wt. % Ti, up to 0.01 wt. % Zr, up to 0.15 wt. % of impurities, and remainder Al.

Illustration 8: The illustration of any preceding or subsequent illustration, wherein the aluminum alloy comprises greater than 50% of recycled aluminum alloy materials.

Illustration 9: The illustration of any preceding or subsequent illustration, wherein the recycled aluminum alloy materials comprise used clad aluminum alloy products comprising a mixture of 3xxx series aluminum alloys and 4xxx series aluminum alloys.

Illustration 10: The illustration of any preceding or subsequent illustration, wherein the aluminum alloy has a solidus temperature of 600° C. or greater.

Illustration 11: The illustration of any preceding or subsequent illustration, wherein an ultimate tensile strength of the aluminum alloy is from 125 MPa to 200 MPa.

Illustration 12: The illustration of any preceding or subsequent illustration, wherein a yield strength of the aluminum alloy is from 35 MPa to 80 MPa.

Illustration 13: The illustration of any preceding or subsequent illustration, wherein the aluminum alloy comprises 0.85-1.25 wt. % Si, up to 0.50 wt. % Fe, 0.2-0.55 wt. % Cu, 1.2-1.8 wt. % Mn, up to 0.15 wt. % Mg, up to 0.1 wt. % Cr, up to 0.1 wt. % Zn, up to 0.1 wt. % Ti, up to 0.05 wt. % Zr, up to 0.15 wt. % of impurities, and remainder Al, wherein the aluminum alloy comprises greater than 50% of recycled aluminum alloy materials comprising used clad aluminum alloy products comprising a mixture of 3xxx series aluminum alloys and 4xxx series aluminum alloys; and wherein the aluminum alloy has a solidus temperature of 600° C. or greater.

Illustration 14: An unclad aluminum alloy product comprising the aluminum alloy of any preceding or subsequent illustration.

Illustration 15: An unclad aluminum alloy product comprising a core layer comprising the aluminum alloy of any preceding or subsequent illustration.

Illustration 16: A clad aluminum alloy product, comprising: a core layer, wherein the core layer has a first side and a second side; at least one cladding layer on the first side or the second side; wherein core layer and/or the cladding layer comprises 0.8-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

Illustration 17: The illustration of any preceding or subsequent illustration, wherein the at least one cladding layer comprises a 1xxx, 3xxx, 4xxx or 7xxx series aluminum alloy.

Illustration 18: A heat exchanger comprising the clad aluminum alloy product of any preceding or subsequent illustration.

Illustration 19: A method of forming a brazing product, the method comprising the steps of: providing one or more metal parts; providing a clad aluminum alloy product on or between the one or more metal parts to form an assembly, wherein the clad aluminum alloy product comprises a core layer; brazing the assembly to join the clad aluminum alloy product and the one or more metal parts to produce a brazed assembly; optionally applying a flux load before brazing; and cooling the brazed assembly, wherein the core layer comprises 0.8-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

Illustration 20: The illustration of any preceding or subsequent illustration, wherein the brazing comprises controlled atmosphere brazing.

Illustration 21: The illustration of any preceding or subsequent illustration, wherein the assembly is brazed at a brazing temperature from 560° C. to 620° C.

Illustration 22: The illustration of any preceding or subsequent illustration, the aluminum alloy comprising 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

Illustration 22: The illustration of any preceding or subsequent illustration, the aluminum alloy comprising 0.7-1.3 wt. % Si, up to 0.6 wt. % Fe, 0.1-0.6 wt. % Cu, 0.9-2 wt. % Mn, up to 0.2 wt. % Mg, up to 0.25 wt. % Cr, up to 0.4 wt. % Zn, up to 0.2 wt. % Ti, up to 0.25 wt. % Zr, up to 0.15 wt. % of impurities, and remainder Al.

Illustration 23: The illustration of any preceding or subsequent illustration, the aluminum alloy comprising 0.7-1.3 wt. % Si, up to 0.4 wt. % Fe, 0.1-0.5 wt. % Cu, 0.9-2 wt. % Mn, up to 0.1 wt. % Mg, up to 0.2 wt. % Cr, up to 0.3 wt. % Zn, up to 0.2 wt. % Ti, up to 0.2 wt. % Zr, up to 0.15 wt. % of impurities, and remainder Al.

Illustration 24: The illustration of any preceding or subsequent illustration, the aluminum alloy comprising 0.7-1.3 wt. % Si, up to 0.55 wt. % Fe, 0.1-0.55 wt. % Cu, 1-2 wt. % Mn, up to 0.2 wt. % Mg, up to 0.15 wt. % Cr, up to 0.2 wt. % Zn, up to 0.15 wt. % Ti, up to 0.15 wt. % Zr, up to 0.15 wt. % of impurities, and remainder Al.

Illustration 25: The illustration of any preceding or subsequent illustration, the aluminum alloy comprising 0.7-1.25 wt. % Si, up to 0.5 wt. % Fe, 0.2-0.5 wt. % Cu, 1.2-1.8 wt. % Mn, up to 0.15 wt. % Mg, up to 0.10 wt. % Cr, up to 0.10 wt. % Zn, up to 0.1 wt. % Ti, up to 0.1 wt. % Zr, up to 0.15 wt. % of impurities, and remainder Al.

Illustration 26: The illustration of any preceding or subsequent illustration, the aluminum alloy comprising 0.7-1.15 wt. % Si, up to 0.38 wt. % Fe, 0.23-0.43 wt. % Cu, 1.4-1.6 wt. % Mn, up to 0.1 wt. % Mg, up to 0.05 wt. % Cr, up to 0.05 wt. % Zn, up to 0.1 wt. % Ti, up to 0.05 wt. % Zr, up to 0.15 wt. % of impurities, and remainder Al.

All patents, publications and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

### EXAMPLES

Sample Alloy 1 and Sample Alloy 2 described herein are modified 3xxx series aluminum alloys that were prepared to have good brazing properties while having good corrosion resistance properties despite being produced from high amounts of recycled aluminum alloy materials. Sample Alloys 1 and 2 have a high Mn content (e.g., from 0.9 wt. % to 2 wt. %) to increase the solidus temperature of the aluminum alloys to compensate for higher amounts of Si and Cu from incorporating recycled aluminum alloy materials. Additionally, Sample Alloys 1-2 include less than 0.2 wt. % of Mg to facilitate controlled atmosphere brazing (CAB), for example, by enabling relatively low flux loads. Thus, the modified aluminum alloy provides recycle-friendly alternative to conventional 3xxx series aluminum alloys (e.g., AA3003 aluminum alloy) used as core alloys in heat exchanger products. The compositions of Sample Alloys 1-2 are provided below in Table 10.

TABLE 10

| | Si | Fe | Cu | Mn | Mg | Zn | Ti | Impurities | Al |
|---|---|---|---|---|---|---|---|---|---|
| Alloy 1 | 1.03 | 0.24 | 0.35 | 1.52 | 0.00 | 0.01 | 0.03 | Up to 0.15 | Balance |
| Alloy 2 | 1.05 | 0.35 | 0.36 | 1.49 | 0.03 | 0.02 | 0.05 | Up to 0.15 | Balance |

Sample Alloys 1 and 2 were used as a core layer to prepare separate cladded aluminum alloy samples. Sample Alloy 1 had a thickness of 0.6 mm. Sample Alloy 1 was cladded on one side with AA4343 aluminum alloy to produce a first cladded aluminum alloy product. The thickness ratio of the cladding layer to the entire sheet was 10% before brazing. Sample Alloy 2 had a thickness of 1.14 mm. Sample Alloy 2 was cladded on one side with AA4045 aluminum alloy to produce a second cladded aluminum alloy product. The thickness ratio of the cladding layer to the entire sheet was 6.5% before brazing.

Both cladded aluminum alloy samples were tested to determine mechanical properties. The tensile properties of each of the cladded aluminum alloy samples were determined using ISO 6892-1 B standards (Sample Type E12.5). The bending behavior was determined using DIN EN 1396:2015 standards, and the grain size was determined using ASTM E112. Each of the cladded aluminum alloy products were tested with respect to its mechanical properties before and after brazing at 600° C. for three minutes. The first cladded aluminum alloy product had a yield strength of 52.8 MPa and a tensile strength of 149.8 MPa before brazing. Additionally, first cladded aluminum alloy product exhibited a tensile elongation of 22.9% before brazing. After brazing at the conditions noted above, the first cladded aluminum alloy product was tested again with respect to its yield strength and its tensile strength. The first cladded aluminum alloy sample exhibited a yield strength of 53.3 MPa and a tensile strength of 158.8 MPa after brazing. The yield strengths of the first cladded aluminum alloy sample were similar before and after brazing. Additionally, the tensile strength of the first cladded aluminum alloy sample increased after brazing.

In addition to determining the mechanical properties of the first cladded aluminum alloy sample, the first cladded aluminum alloy sample was tested to observe the bending behavior prior to brazing. With respect to a longitudinal direction (e.g., parallel to a grain orientation of the core layer) and a long transverse direction (e.g., the largest dimension transverse to the longitudinal direction), the first cladded aluminum alloy sample had no cracking with a bending angle of 180° and a radius of zero. Additionally, the grain size of the core alloy for the first cladded aluminum alloy sample was characterized before and after brazing. The grain size (average) of the first cladded aluminum alloy sample was ASTM Size No. 6 or finer before and after brazing, indicating that the grain size remained largely unchanged after brazing.

The second cladded aluminum alloy sample was tested with respect to its mechanical properties before and after brazing at 600° C. for five minutes. The second cladded aluminum alloy sample had a 0.2% offset yield strength of 52 MPa and a tensile strength of 153 MPa before brazing. Additionally, the second cladded aluminum alloy sample exhibited a tensile elongation of 26.4% before brazing. After brazing, the second cladded aluminum alloy sample was tested again with respect to its yield strength and its tensile strength. The second cladded aluminum alloy sample exhibited a yield strength of 52.8 MPa and a tensile strength of 163.5 MPa after brazing. As with the first cladded aluminum alloy sample, the respective yield strengths of the second cladded aluminum alloy sample before and after brazing were similar. Additionally, the tensile strength of the second cladded aluminum alloy sample was higher after brazing, indicating that Sample Alloy 2 exhibits suitable brazing properties despite being produced from high amounts of recycled aluminum alloy materials.

The second cladded aluminum alloy sample also was tested to determine the bending behavior of the second cladded aluminum alloy sample prior to brazing. With respect to the longitudinal direction and the long transverse direction, the second cladded aluminum alloy sample had no cracking with a bending angle of 180° and a radius of zero. The grain size of the second cladded aluminum alloy sample was ASTM Grain Size No. 7 or finer before and after brazing. Similar to the first cladded aluminum alloy sample, the grain size of the second cladded aluminum alloy sample remained largely unchanged after brazing.

1. An aluminum alloy comprising 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

2. The aluminum alloy of claim 1, comprising 0.7-1.3 wt. % Si, up to 0.6 wt. % Fe, 0.1-0.6 wt. % Cu, 0.9-2 wt. % Mn, up to 0.2 wt. % Mg, up to 0.25 wt. % Cr, up to 0.4 wt. % Zn, up to 0.2 wt. % Ti, up to 0.25 wt. % Zr, up to 0.15 wt. % of impurities, and remainder Al.

3. The aluminum alloy of claim 1, comprising 0.8-1.3 wt. % Si, up to 0.4 wt. % Fe, 0.1-0.5 wt. % Cu, 0.9-2 wt. % Mn, up to 0.1 wt. % Mg, up to 0.2 wt. % Cr, up to 0.3 wt. % Zn, up to 0.2 wt. % Ti, up to 0.2 wt. % Zr, up to 0.15 wt. % of impurities, and remainder Al.

4. The aluminum alloy of claim 1, comprising 0.85-1.3 wt. % Si, up to 0.55 wt. % Fe, 0.1-0.55 wt. % Cu, 1-2 wt. % Mn, up to 0.2 wt. % Mg, up to 0.15 wt. % Cr, up to 0.2 wt. % Zn, up to 0.15 wt. % Ti, up to 0.15 wt. % Zr, up to 0.15 wt. % of impurities, and remainder Al.

5. The aluminum alloy of claim 1, comprising 0.85-1.25 wt. % Si, up to 0.5 wt. % Fe, 0.2-0.5 wt. % Cu, 1.2-1.8 wt. % Mn, up to 0.15 wt. % Mg, up to 0.10 wt. % Cr, up to 0.10 wt. % Zn, up to 0.1 wt. % Ti, up to 0.1 wt. % Zr, up to 0.15 wt. % of impurities, and remainder Al.

6. The aluminum alloy of claim 1, comprising 0.85-1.15 wt. % Si, up to 0.38 wt. % Fe, 0.23-0.43 wt. % Cu, 1.4-1.6 wt. % Mn, up to 0.1 wt. % Mg, up to 0.05 wt. % Cr, up to 0.05 wt. % Zn, up to 0.1 wt. % Ti, up to 0.05 wt. % Zr, up to 0.15 wt. % of impurities, and remainder Al.

7. The aluminum alloy of claim 1, comprising 0.9-1.1 wt. % Si, up to 0.35 wt. % Fe, 0.23-0.43 wt. % Cu, 1.4-1.6 wt. % Mn, up to 0.05 wt. % Mg, up to 0.03 wt. % Cr, up to 0.04 wt. % Zn, up to 0.1 wt. % Ti, up to 0.01 wt. % Zr, up to 0.15 wt. % of impurities, and remainder Al.

8. The aluminum alloy of claim 1, wherein the aluminum alloy comprises greater than 50% of recycled aluminum alloy materials.

9. The aluminum alloy of claim 8, wherein the recycled aluminum alloy materials comprise used clad aluminum alloy products comprising a mixture of 3xxx series aluminum alloys and 4xxx series aluminum alloys.

10. The aluminum alloy of claim 1, wherein the aluminum alloy has a solidus temperature of 600° C. or greater.

11. The aluminum alloy of claim 1, wherein an ultimate tensile strength of the aluminum alloy is from 125 MPa to 200 MPa.

12. The aluminum alloy of claim 1, wherein a yield strength of the aluminum alloy is from 35 MPa to 80 MPa.

13. The aluminum alloy of claim 1, wherein the aluminum alloy comprises 0.85-1.25 wt. % Si, up to 0.50 wt. % Fe, 0.2-0.55 wt. % Cu, 1.2-1.8 wt. % Mn, up to 0.15 wt. % Mg, up to 0.1 wt. % Cr, up to 0.1 wt. % Zn, up to 0.1 wt. % Ti, up to 0.05 wt. % Zr, up to 0.15 wt. % of impurities, and remainder Al,
wherein the aluminum alloy comprises greater than 50% of recycled aluminum alloy materials comprising used clad aluminum alloy products comprising a mixture of 3xxx series aluminum alloys and 4xxx series aluminum alloys; and
wherein the aluminum alloy has a solidus temperature of 600° C. or greater.

14. An unclad aluminum alloy product comprising the aluminum alloy of claim 1.

15. A clad aluminum alloy product comprising a core layer comprising the aluminum alloy of claim 1.

16. A clad aluminum alloy product, comprising:
a core layer, wherein the core layer has a first side and a second side;
at least one cladding layer on the first side or the second side;
wherein core layer and/or the cladding layer comprises 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

17. The clad aluminum alloy product of claim 16, wherein the at least one cladding layer comprises a 1xxx, 3xxx, 4xxx or 7xxx series aluminum alloy.

18. A heat exchanger comprising the clad aluminum alloy product of claim 16.

19. A method of forming a brazing product, the method comprising the steps of: providing one or more metal parts;
providing a clad aluminum alloy product on or between the one or more metal parts to form an assembly, wherein the clad aluminum alloy product comprises a core layer;
brazing the assembly to join the clad aluminum alloy product and the one or more metal parts to produce a brazed assembly;
optionally applying a flux load before brazing; and
cooling the brazed assembly, wherein the core layer comprises 0.7-1.3 wt. % Si, up to 0.6 wt. % Fe, 0.1-0.6 wt. % Cu, 0.9-2 wt. % Mn, up to 0.2 wt. % Mg, up to 0.3 wt. % Cr, up to 0.5 wt. % Zn, up to 0.2 wt. % Ti, up to 0.3 wt. % Zr, up to 0.15 wt. % of impurities, and remainder Al.

20. The method of claim 19, wherein the brazing the assembly comprises controlled atmosphere brazing at a brazing temperature from 560° C. to 620° C.

21. (canceled)
